(19) United States
(12) Patent Application Publication
(10) Pub. No.: US 2026/0065143 A1
(43) Pub. Date: Mar. 5, 2026

(54) ENTROPY-BASED EARLY STOPPING FOR SPECULATIVE DECODING IN GENERATIVE MACHINE LEARNING MODELS

(71) Applicant: QUALCOMM Incorporated, San Diego, CA (US)

(72) Inventors: Sudhanshu AGRAWAL, San Diego, CA (US); Wonseok JEON, San Diego, CA (US); Mingu LEE, San Diego, CA (US)

(21) Appl. No.: 18/983,103

(22) Filed: Dec. 16, 2024

Related U.S. Application Data
(60) Provisional application No. 63/688,654, filed on Aug. 29, 2024.

(51) Int. Cl. G06N 20/00

(52) U.S. Cl. CPC G06N 20/00

(57) ABSTRACT

Certain aspects of the present disclosure provide techniques and apparatus for machine learning. In an example method, a set of tokens having a probability distribution is generated using a secondary generative machine learning model associated with a primary generative machine learning model. An entropy of the set of tokens is computed based on the probability distribution, and one or more stopping criteria for the secondary generative machine learning model are determined. A next token is generated using the primary generative machine learning model after exiting from the secondary generative machine learning model based on the first entropy and the one or more stopping criteria.

### CROSS-REFERENCE TO RELATED APPLICATION(S)

The present application for patent claims the benefit of and priority to U.S. Provisional Patent Application No. 63/688,654, filed Aug. 29, 2024, which is hereby incorporated by reference herein in its entirety for all applicable purposes.

### INTRODUCTION

Aspects of the present disclosure relate to machine learning.

A wide variety of machine learning model architectures have been trained to perform an assortment of diverse tasks, including computer vision tasks, language tasks, classification and regression tasks, and the like. Recently, research has yielded substantial success in using large language models (LLMs), large vison models (LVMs), and/or large multimodal models (LMMs) to process and generate output data. Often, machine learning models (especially LLMs, LVMs, and LMMs) have many parameters (e.g., millions or even billions), resulting in significant model size, as well as substantial computational expense and time to generate output using the model.

Some recent efforts to mitigate the computational expense of such generative models include speculative decoding, where a less computationally expensive model (referred to in some aspects as a “draft model”) can be used to generate a subset of the tokens in the output (rather than using the larger model, often referred to as the “target model,” for all tokens). Some approaches to speculative decoding utilize certain criteria to control switches between using the draft model and the target model.

### BRIEF SUMMARY

Certain aspects of the present disclosure provide a processor-implemented method, comprising: generating, using a secondary generative machine learning model associated with a primary generative machine learning model, a first set of tokens having a first probability distribution; computing a first entropy of the first set of tokens based on the first probability distribution; determining one or more stopping criteria for the secondary generative machine learning model; and generating a next token using the primary generative machine learning model after exiting from the secondary generative machine learning model based on the first entropy and the one or more stopping criteria.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict example features of certain aspects of the present disclosure and are therefore not to be considered limiting of the scope of this disclosure.

FIG. 1 depicts an example workflow for utilizing entropy measurements to perform speculative decoding, according to some aspects of the present disclosure.

FIG. 2 is a flow diagram depicting an example method for entropy-based speculative decoding, according to some aspects of the present disclosure.

FIG. 3 is a flow diagram depicting an example method for generating draft tokens using entropy-based exit criteria, according to some aspects of the present disclosure.

FIG. 4 is a flow diagram depicting an example method for adaptive exiting criteria in entropy-based speculative decoding, according to some aspects of the present disclosure.

FIG. 5 is a flow diagram depicting an example method for speculative decoding, according to some aspects of the present disclosure.

FIG. 6 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for providing improved machine learning. Specifically, in some aspects of the present disclosure, techniques for improved speculative decoding via entropy-based early exiting are provided.

Many model architectures, such as transformer-based models (e.g., LLMs) and diffusion models (e.g., LVMs) have shown great promise in generating useful output data. However such generative models are often slow at inference time (e.g., taking substantial time to generate output tokens, where each token generally corresponds to a portion of the model output, such as a single character or word, a portion of word, a pixel or other portion of an image, and the like) and are similarly computationally expensive (e.g., consuming substantial memory, as well as processor time and energy, and resulting in substantial heat generation). As a result, a variety of techniques have been developed to accelerate the token generation rate and/or reduce the computational expense of the token generation. One such technique includes speculative decoding, where a drafting phase is performed to produce “draft” tokens using a relatively less expensive and/or quicker draft model. These draft tokens can then undergo a verification phase to determine whether the draft tokens are “accepted” or “rejected” (e.g., by the slower and/or more computationally expensive target model) to produce the final set of output tokens.

However, some speculative decoding techniques utilize a static or fixed draft length (e.g., the number of draft tokens produced during each drafting phase and prior to verification is fixed). This fixed draft length leads to poor performance in many cases, particularly when the target model rejects many of the tokens and/or when there is a high variance in the number of draft tokens successfully verified by the target model. That is, if the target model continues to reject a large portion of the draft tokens, the time and computational expense spent generating the draft tokens are wasted. Similarly, if the acceptance rate varies substantially, a fixed draft length results in inefficiencies on both ends of the spectrum (e.g., not enough time and resources are spent generating draft tokens for times when the target model accepts a large percentage of the draft tokens, while too much time and resources are spent generating draft tokens for times when the target model rejects a large percentage of the draft tokens).

In some systems, simplistic techniques for early exiting of the drafting phase have been proposed to mitigate these concerns. For example, in some systems, the highest (e.g., largest) probability of the generated (draft) logits (output by the draft model) has been used as a proxy for confidence in the draft tokens. If the highest logit is below a threshold, some systems presume that the most recently generated draft output is low quality, and may therefore terminate the drafting phase. However, these max-confidence-based adaptive draft length techniques ignore the remainder of the probability distribution generated by the draft model, often leading to poor performance (particularly in cases where token generation is not purely greedy).

In some systems, other techniques to improve speculative decoding have involved training of a separate predictor layer used to determine when to perform early exiting from the draft model or drafting phase. However, these additional predictor approaches can produce mixed results depending on the particular data used to train the predictors. Further, the training and use of an additional prediction model incurs additional computational costs due to the extra parameters involved, as well as the additional training time consumed.

In some aspects of the present disclosure, the entropy of the data generated by the draft model is used to define stopping criteria for the drafting phase. That is, rather than considering a subset of the generated output (e.g., the highest scored logit), certain aspects of the present disclosure can enable evaluation of the entire probability distribution (e.g., across all logits). Such an approach can significantly improve the speculative decoding process, as this entropy-based approach takes into account the full spectrum of data generated by the draft model. For example, even if the highest-scored token or logit has a relatively low probability, the token may still be useful and accurate if the remaining token scores are substantially lower. In some aspects, by computing the entropy of the output probability distribution of the draft model, the speculative decoding system can better determine when to terminate the drafting phase.

In some aspects, as used herein, a “target model” may generally refer to a generative machine learning model from which output generated data is desired. For example, the target model may correspond to an LLM being used to generate outputs. In some aspects, the target model may incur fairly substantial latency and/or computational expense to generate output tokens (e.g., due to the size of the model). Similarly, as used herein, a “draft model” may generally refer to a smaller and/or less complex generative machine learning model that can be used as a surrogate for the target model in some cases (e.g., generating similar output, potentially with somewhat reduced accuracy or quality). Generally, the draft model may incur less latency and/or computational expense to generate output tokens, as compared to the target model, such as due to the relatively smaller size and/or lower complexity of the draft model.

Generally, the particular architecture or techniques used to implement the draft model may vary depending on the particular implementation. For example, in some aspects, the draft model may comprise a separate or discrete model from the target model, or may be implemented as a subset of the target model's layers (e.g., where the draft model corresponds to every other layer of the target model). In some aspects, the draft model may be implemented using extra parameters in the target model itself to generate draft tokens.

In some aspects, in addition to or instead of evaluating the entropy of the draft model (e.g., the entropy of the probability distributions generated by the draft model) during drafting, the speculative decoding system can utilize adaptive stopping criteria based on the acceptance rate of the target model. For example, during each verification phase (after a set of draft tokens have been generated during the drafting phase), the system may determine the acceptance rate of the draft tokens for the current drafting phase and/or one or more prior drafting phases, and may adaptively adjust the stopping criteria used to define when the drafting phase ends accordingly, as discussed in more detail below.

### Example Workflow for Utilizing Entropy Measurements to Perform Speculative Decoding

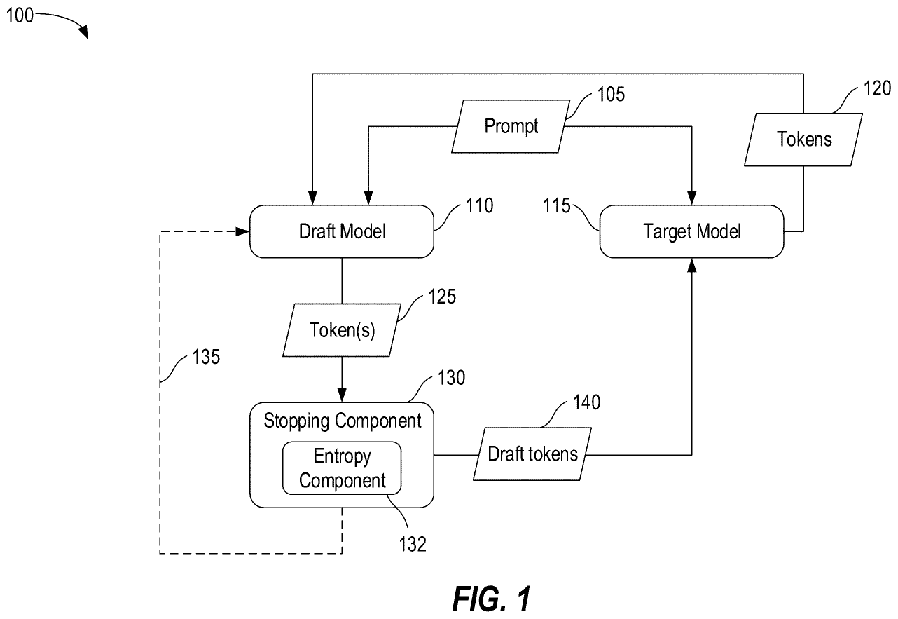

FIG. 1 depicts an example workflow 100 for utilizing entropy measurements to perform speculative decoding, according to some aspects of the present disclosure. In some aspects, the workflow 100 is performed by a speculative decoding system. That is, the workflow 100 may be performed by any computing system configured to perform speculative decoding, as discussed above and herein. In some aspects, the workflow 100 may be performed by multiple discrete systems. For example, one computing system (e.g., a portable device) may implement the draft generative model, while another computing system (e.g., a server) implements the target generative model. In other aspects, the same computing system may implement both the draft generative model and the target generative model.

In the illustrated example, a prompt 105 (also referred to in some aspects as a “query”) is accessed by a draft model 110 and a target model 115. As used herein, “accessing” data may generally include receiving, retrieving, obtaining, collecting, generating, or otherwise gaining access to the data. For example, the prompt 105 may be received from a user or entity that uses the machine learning model(s) to generate output. Generally, the particular content and format of the prompt 105 may vary depending on the particular implementation. For example, in some cases, the prompt 105 may comprise textual information (e.g., natural language text) for use as input to an LLM to generate textual output (e.g., a natural language text response).

In the depicted workflow 100, the target model 115 (also referred to in some aspects as the “primary model,” the “primary machine learning model,” and/or as the “primary generative machine learning model”) generally corresponds to a generative machine learning model used to generate output data based on input prompts. For example, as discussed above, the target model 115 may correspond to an LLM, LVM, LMM, or the like. In some aspects, the target model 115 may be relatively computationally expensive (e.g., incurring substantial latency and/or computational resource usage) during runtime. Further, in the illustrated example, the draft model 110 (also referred to in some aspects as the “secondary model,” the “secondary machine learning model,” and/or as the “secondary generative machine learning model”) generally corresponds to a generative machine learning model that can also be used to generate output data based on input prompts. In some aspects, as discussed above, the draft model 110 may be relatively less computationally expensive than the target model 115 (e.g., incurring less latency and/or computational resource usage, as compared to the target model 115) during runtime.

In some aspects, the draft model 110 may be somewhat less accurate or reliable than the target model 115. However, not all tokens in a generated output are equally “difficult” to generate. Therefore, in some aspects, the draft model 110 may be reliably used to generate some tokens, even if the target model 115 is relied upon for other tokens. Knowing the “difficulty” of a given token (before drafting the token) is, generally speaking, nearly impossible. In some aspects, therefore, the depicted workflow 100 can be used to implement speculative decoding. Generally, as discussed above, speculative decoding involves using the target model 115 to generate some set of tokens in the output, while allowing the draft model 110 to generate another set of one or more tokens. These tokens generated by the draft model 110 (referred to as “draft tokens” in some aspects) can then be evaluated (e.g., using the target model 115) to verify the draft tokens. That is, the target model 115 may accept one or more of the draft tokens, and the target model 115 may reject one or more of the draft tokens (e.g., because the token is too dissimilar from what the target model 115 would have generated).

In some aspects, because the draft model 110 is less computationally complex than the target model 115, the set of draft tokens can be generated more rapidly and with less computational expense, as compared to generating the set using the target model 115 alone. Further, because the target model 115 may evaluate multiple draft tokens in parallel (e.g., evaluating the entire sequence of draft tokens at once), the target model 115 can be used to quickly verify the draft tokens. By combining these features, the workflow 100 can substantially accelerate the output generation process.

In the illustrated example, the target model 115 may process the prompt 105 to generate a set of one or more tokens 120. As used herein, a “token” corresponds to a unit of output of the model(s). Generally, the particular format and content of a token may vary depending on the particular implementation. For example, in some aspects, the tokens 120 comprise words, phrases, alphanumeric characters and/or symbols, and the like. Generally, the particular number of tokens 120 to be generated using the target model 115 may vary depending on the particular implementation. For example, in some aspects, the computing system may generate a single token 120 using the target model 115 in between each drafting phase (e.g., before using the draft model 110). As another example, the computing system may use the target model 115 to generate two or more tokens 120 between drafting phases.

In the illustrated workflow 100, these initial tokens 120 are provided, along with the prompt 105, to the draft model 110, to generate a new set of one or more tokens 125. In some aspects, as discussed above, the tokens 125 may be referred to as “draft” tokens to indicate that the tokens 125 were generated by the draft model 110. Generally, the particular number of tokens 125 to be generated using the draft model 110 may vary depending on the particular implementation. For example, in some aspects, the computing system may generate a single token 125 using the draft model 110 in between each evaluation of the early-exit criteria during the drafting phase (e.g., before evaluating the token 125 using the early-exit criteria). As another example, the computing system may use the draft model 110 to generate two or more tokens 125 between each evaluation of the early-exit criteria.

In the illustrated example, the token(s) 125 are accessed by a stopping component 130 to determine whether to stop the drafting phase. As used herein, stopping the drafting phase (also referred to in some aspects as “early exiting” or “exiting” from the drafting phase and/or from the draft model) generally corresponds to determining to use the target model 115 for the next one or more token(s) of the output, rather than using the draft model 110 for the next token(s).

In the illustrated workflow 100, the stopping component 130 includes an entropy component 132. The entropy component 132 may generally be used to evaluate the entropy of the draft model 110 (e.g., the entropy of the outputs of the draft model 110) based on the output of the draft model 110. For example, in some aspects, when generating the token 125, the draft model 110 also generates a set of probabilities for each of one or more output tokens (e.g., a probability distribution where the particular probability score for a particular token indicates the probability that the particular token should be selected as the token 125 output by the draft model 110). In some aspects, the entropy component 132 can compute the entropy of this probability distribution (corresponding to the newly generated token 125) to determine whether to exit the drafting phase.

For example, suppose the probability distribution of the set of candidate tokens generated by the draft model 110 is defined as DM, and the entropy of the probability distribution is defined as H(DM). In some aspects, the stopping component 130 may compare this entropy against one or more thresholds to determine whether to early exit the drafting phase. In some aspects, rather than comparing the entropy directly against one or more thresholds, the stopping component 130 may use an equation, such as Equation 1 below, to generate an early-exit score for the draft model 110 (e.g., for the token 125). In Equation 1, score is the early-exit score, and γ is a hyperparameter.

$$score = 1 - \sqrt{γ H ( D M )} \qquad ( 1 )$$

In some aspects, this early-exit score may be compared against an early-exit threshold λ. For example, in some aspects, if score<λ, the stopping component 130 may determine that the early-exit criteria are satisfied. Generally, the stopping component 130 may use a variety of inequalities to evaluate the exit score, including strictly less than, not greater than (e.g., less than or equal to), strictly greater than, not less than (e.g., greater than or equal to), and the like. In some aspects, the stopping component 130 may therefore determine that the early-exit criteria are satisfied if the entropy is high (e.g., the drafting phase should be stopped when the early-exit score is low), while the early-exit criteria may be not satisfied if the entropy is low (e.g., the drafting phase should continue when the early-exit score is high).

In some aspects, the early-exit threshold A is a hyperparameter. In some aspects, the early-exit threshold may be a dynamic or adaptive threshold. For example, in some aspects, the early-exit threshold may be defined dynamically based on the moving average of the acceptance rate of the target model 115 with respect to the draft tokens generated by the draft model 110, as discussed in more detail below.

Although the illustrated example depicts use of entropy to determine exit criteria from the drafting phase, in some aspects, the stopping component 130 may use a variety of other criteria to determine when to exit the drafting phase. For example, the stopping component 130 may additionally or alternatively determine whether the current sequence of draft tokens (generated by the draft model 110 during the current drafting phase) meets a defined maximum draft length hyperparameter (e.g., a defined maximum number of draft tokens that should be generated in a given drafting phase).

In the illustrated workflow 100, if the stopping component 130 determines to continue the drafting phase, as illustrated by the dotted arrow 135, the draft model 110 may be prompted to generate a next token 125 (e.g., using the prompt 105, the tokens 120, and the previously generated token 125 as input). This process can then be repeated (e.g., generating and evaluating a new entropy based on the new token 125) until the one or more stopping criteria are satisfied.

As illustrated, if the stopping component 130 determines to exit from the draft model 110 (e.g., due to high entropy of the output), the set of generated draft tokens 140 is provided for verification to the target model 115. That is, for each iteration of drafting, the draft model 110 may generate and add a new token to the sequence of draft tokens 140 (e.g., adding the highest-scored token at each iteration). When the drafting phase terminates, this sequence of draft tokens 140 may be provided to the target model 115.

In some aspects, as discussed above, the target model 115 may be used to verify the draft tokens 140. For example, the prompt 105, any tokens 120 that have already been drafted by the target model 115, and the set of draft tokens 140 may be provided as input, allowing the target model 115 to verify (e.g., accept) or reject each token of the sequence of draft tokens 140. For example, the target model 115 may generate a score for each token in the sequence of draft tokens 140, accepting tokens having a score above a threshold (e.g., indicating a higher probability that the target model 115 would have generated the same token) and rejecting tokens having a score below the threshold (e.g., indicating a low probability that the target model 115 would have generated the same token).

In some aspects, this verification process also results in generation of a new next token 120 to be added to the sequence of (accepted) tokens. As illustrated, this updated sequence of tokens can then be provided to the draft model 110 to begin the next drafting phase, as discussed above. Although the illustrated example suggests that the target model 115 is used to generate the first token(s) in the output sequence (followed by alternating between the draft model 110 and the target model 115), in some aspects, the draft model 110 may be used to generate the first token(s) (followed by alternating between the draft model 110 and the target model 115).

In some aspects, as discussed above, the acceptance rate of the target model 115 may be used to dynamically or adaptively update the early-exit threshold for the drafting phase. For example, in some aspects, the computing system may calculate an updated moving average acceptance rate of the target model 115 using Equation 2 below, where α_{updated_ma} is the updated moving average acceptance rate, β₁ is a hyperparameter, α_{previous_ma} is the previous moving average acceptance rate (e.g., determined after the prior drafting phase), and α_{current} is the current acceptance rate of the target model 115 (e.g., determined based on the set of draft tokens 140 after the most recent drafting phase). For example, α_{current} may be computed as the percentage of tokens, from the set of draft tokens 140 generated during the immediately prior drafting phase, which the target model 115 accepted.

$${α}_{updated \_ ma} = {β}_{1} {α}_{previous \_ ma} + ( 1 - {β}_{1} ) {α}_{current} \qquad ( 2 )$$

In some aspects, the computing system may then determine a target acceptance threshold or rate (e.g., a desired or target percentage of draft tokens, which may be defined as a hyperparameter). Generally, balancing the target acceptance rate can optimize or at least improve the computational efficiency of the models.

In some aspects, if the updated moving average acceptance rate is less than (or less than or equal to) the target acceptance rate, the computing system may generate a new updated early-exit threshold (e.g., by increasing the current threshold), such as by using Equation 3 below, where λ′ is the updated or new early-exit threshold, λ is the current threshold, and ε is a hyperparameter. By increasing the early-exit threshold, the computing system may make the stopping component 130 more likely to terminate the drafting phase (e.g., ending drafting when entropy is relatively lower, as compared to the prior round), which may result in an increased acceptance rate of the draft tokens 140.

$${λ}^{′} = min ( 1 , λ + ϵ ) \qquad ( 3 )$$

In some aspects, if the updated moving average acceptance rate is greater than (or greater than or equal to) the target acceptance rate, the computing system may determine a maximum length of the sequence of draft tokens (e.g., a maximum draft length), which may be defined as a hyperparameter, as well as the number of draft tokens, from the sequence of draft tokens 140, which were accepted by the target model 115.

In some aspects, if the number of accepted draft tokens is equal to the maximum draft length for the computing system, the computing system may leave the early-exit threshold unchanged (e.g., λ′=λ).

In some aspects, if the number of accepted draft tokens is less than the maximum draft length for the computing system, the computing system may generate a new updated early-exit threshold (e.g., by decreasing the current threshold), such as by using Equation 4 below. By decreasing the early-exit threshold, the computing system may make the stopping component 130 more likely to continue the drafting phase (e.g., continuing drafting when entropy is relatively higher, as compared to the prior round), which may result in increased draft lengths (e.g., nearer to the maximum length), thereby improving the computational efficiency of generating the output.

$${λ}^{′} = max ( 0 , λ - ε ) \qquad ( 4 )$$

In some aspects, rather than using the updated threshold directly, the computing system may generate the updated moving average of the threshold, such as using Equation 5 below, where λ_{updated} is the updated early-exit threshold, β₂ is a hyperparameter, λ is the previous threshold (e.g., determined after the prior drafting phase), and λ′ is the updated threshold (e.g., determined as discussed above using Equations 3 and 4).

$${λ}_{updated} = {β}_{2} λ + ( 1 - {β}_{2} ) {λ}^{′} \qquad ( 5 )$$

Advantageously, this dynamic early-exit thresholding may automatically improve the computational efficiency of the system, enabling improved model output generation with reduced computational expense and/or latency. Although not depicted in the illustrated example, in some aspects, the output generation can continue (token by token) until one or more termination criteria are satisfied. For example, the computing system may continue to generate tokens until interrupted (e.g., until the requesting entity terminates the process), until a “complete” token or other token indicating the end of the output is generated and/or accepted, and/or until the sequence of output tokens reaches a maximum output length. This generated output can then be output by the computing system (e.g., returned to the requesting entity).

### Example Method for Entropy-Based Speculative Decoding

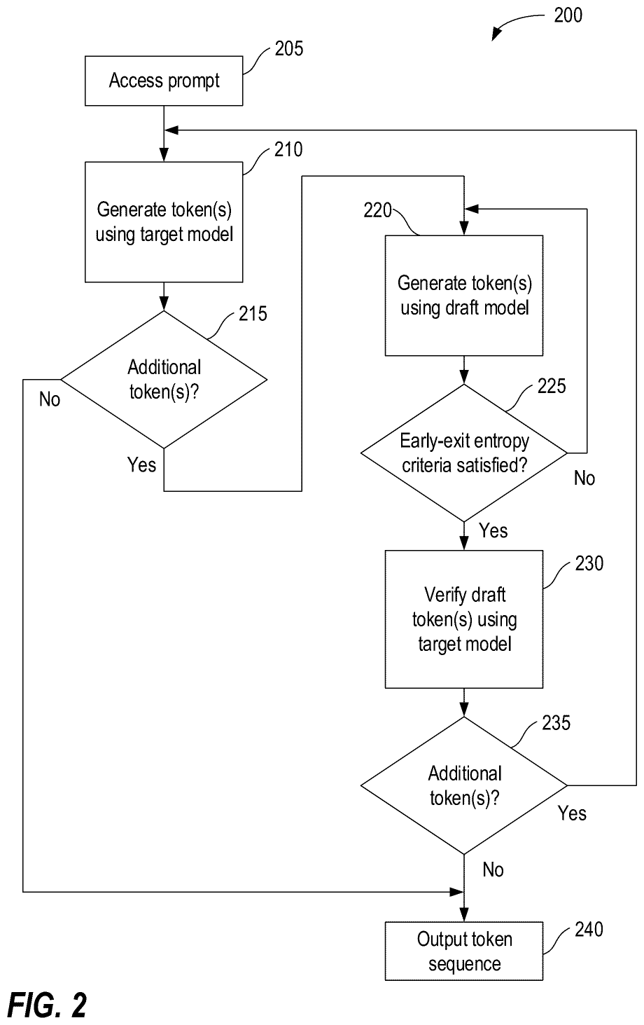

FIG. 2 is a flow diagram depicting an example method 200 for entropy-based speculative decoding, according to some aspects of the present disclosure. In some aspects, the method 200 is performed by a computing system (e.g., a speculative decoding system), such as the computing system discussed above with reference to FIG. 1.

At block 205, the computing system accesses a prompt (e.g., the prompt 105 of FIG. 1) to generate a generative machine learning model output. For example, as discussed above, the prompt may comprise text (e.g., natural language text) describing the desired output (e.g., asking a question, requesting an image be generated, and the like). The particular contents and format of the prompt may vary depending on the particular implementation.

At block 210, the computing system generates one or more tokens (e.g., the tokens 120 of FIG. 1) based on the prompt and using a target generative machine learning model (e.g., the target model 115 of FIG. 1). As discussed above, the target model generally corresponds to a generative machine learning model that can be used to generate output based on the prompt. In some aspects, the target model has relatively high computational complexity and/or latency (as compared to the draft model, discussed in more detail below). In some aspects, the computing system generates a single “initial” token at block 210 using the target model. In some aspects, the computing system may bypass block 210 during the initial iteration of generating output (e.g., the computing system may generate the initial token(s) using the draft model, rather than the target model). Generally, the computing system (e.g., by the draft model, the target model) may generate any number of tokens at block 210.

At block 215, the computing system determines whether to generate at least one additional token for the output of the model. Generally, the computing system may evaluate a variety of criteria to determine whether to terminate the output generation. For example, in some aspects, the computing system may determine whether the most recently generated token(s) (e.g., generated at block 210) include an “end” token (or other token signifying the end of the generated output). As another example, in some aspects, the computing system may determine whether a defined (maximum) number of tokens have been generated (e.g., whether the generated output has reached the maximum length imposed on the models).

If, at block 215, the computing system determines that no additional tokens remain to be generated, the method 200 continues to block 240, discussed in more detail below. If, at block 215, the computing system determines that at least one additional token should be generated for the output, the method 200 continues to block 220.

At block 220, the computing system generates one or more tokens (e.g., the tokens 125 of FIG. 1) based on the prompt and using a draft generative machine learning model (e.g., the draft model 110 of FIG. 1). As discussed above, the draft model generally corresponds to a generative machine learning model that can be used to generate output based on the prompt (and, in some aspects, the current sequence of output tokens that has already been generated and/or accepted by the target model). In some aspects, the draft model has relatively lower computational complexity and/or latency (as compared to the target model, discussed above). For example, the draft model may use fewer layers or operations (e.g., every other layer of the target model), a different model architecture, and the like.

In some aspects, the computing system generates a single “draft” token at block 220 using the draft model. That is, during the drafting phase (which begins at block 220), the computing system may generate one draft token at a time, evaluating drafting early-exit criteria between each draft token generation. In some aspects, at block 220, the computing system generates a set of tokens (e.g., a single output of the draft model, comprising a set of probabilities for each of the set of tokens), and selects one of the tokens as the “draft token” for the current iteration of the drafting phase (e.g., by selecting the token having the highest probability).

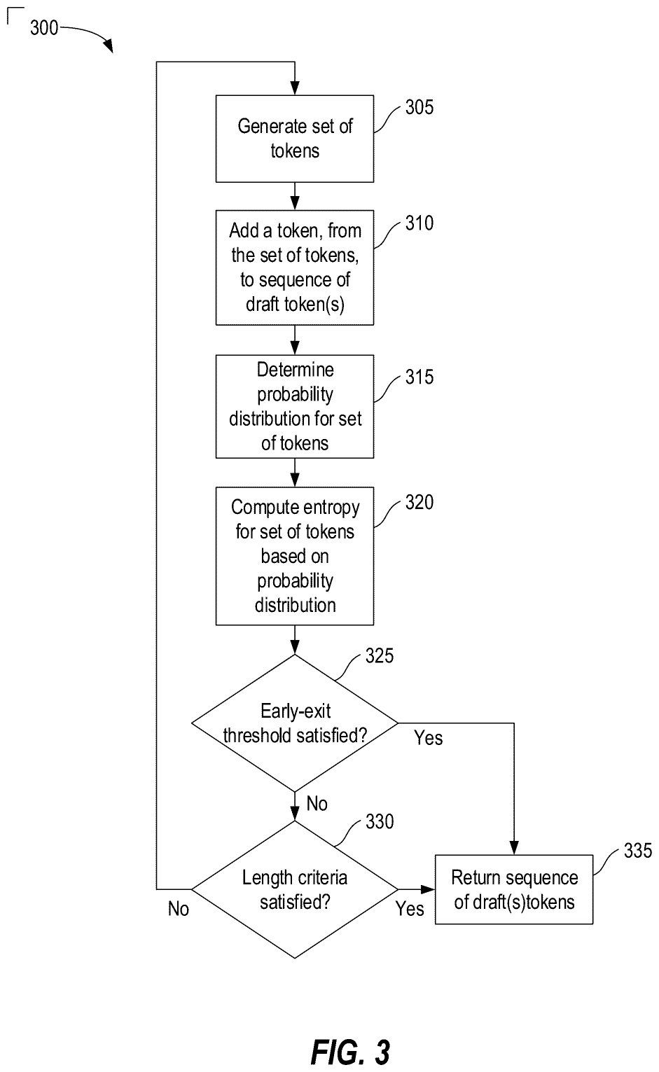

At block 225, the computing system determines whether one or more early-exit entropy criteria are satisfied. For example, as discussed above, the computing system may determine the entropy of the output of the draft model (generated at block 220), and evaluate this entropy against one or more criteria (e.g., using Equation 1 above). One example method for generating the tokens (at block 220) and evaluating the early-exit entropy criteria (at block 225) is discussed in more detail below with reference to FIG. 3.

Although not depicted in the illustrated example, in some aspects, the computing system may similarly evaluate other exit criteria at block 225, such as whether the most recently generated draft token (e.g., generated at block 220) includes a token signifying the end of the generated output, whether a defined (maximum) number of tokens have been generated (e.g., whether the generated output has reached the maximum length imposed on the models), and the like.

If, at block 225, the computing system determines that the exit criteria are not satisfied (e.g., that the computing system should continue the drafting phase and use the draft model to generate at least one more token), the method 200 returns to block 220 to generate at least one additional token using the draft model. In some aspects, as discussed above, this may be referred to as generating a “next” token using the draft model.

If, at block 225, the computing system determines that the early-exit entropy criteria (or other exit criteria) are satisfied, the method 200 continues to block 230. At block 230, the computing system verifies the set of draft token(s) (generated during one or more iterations of block 220) using the target model. For example, as discussed above, the computing system may process the draft tokens as input to the target model, allowing the target model to accept or reject each draft token (or, in some aspects, allowing the computing system to score each draft token, where the scores can be evaluated to accept or reject each).

At block 235, the computing system determines whether to generate at least one additional token for the output of the model. As discussed above, the computing system may generally evaluate a variety of criteria to determine whether to terminate the output generation. For example, in some aspects, the computing system may determine whether the most recently generated or verified token(s) (e.g., generated at block 220 and verified at block 230) include an “end” token (or other token signifying the end of the generated output). As another example, in some aspects, the computing system may determine whether a defined (maximum) number of tokens have been generated (e.g., whether the generated (and verified) output has reached the maximum length imposed on the models).

If, at block 235, the computing system determines that no additional tokens remain to be generated, the method 200 continues to block 240, discussed in more detail below. If, at block 235, the computing system determines that at least one additional token should be generated for the output, the method 200 returns to block 210 to generate another “next” token using the target model. In some aspects, as discussed above, the computing system may alternatively generate the new token while verifying the draft tokens. That is, the next token generated by the target model may be inherently or implicitly generated during the verification of draft tokens at block 230. The method 200 then continues to block 215, discussed above in more detail.

Returning to block 240, once the computing system determines that no additional tokens should be generated (e.g., at block 215 and/or block 235), the computing system outputs the generated token sequence. As discussed above, this sequence may generally include zero or more tokens generated by the target model, as well as zero or more draft tokens generated by the draft model and verified by the target model. For example, as discussed above, the computing system may output the sequence of tokens as a response to the entity that provided the prompt, or as input to a separate downstream computing system.

### Example Method for Generating Draft Tokens Using Entropy-Based Exit Criteria

FIG. 3 is a flow diagram depicting an example method 300 for generating draft tokens using entropy-based exit criteria, according to some aspects of the present disclosure. In some aspects, the method 300 is performed by a computing system (e.g., a speculative decoding system), such as the computing system discussed above with reference to FIGS. 1-2. In some aspects, the method 300 provides additional detail for the blocks 220 and/or 225 of FIG. 2.

At block 305, the computing system generates a set of tokens (e.g., the tokens 125) using a draft generative machine learning model (e.g., the draft model 110 of FIG. 1). For example, as discussed above, the computing system may process the prompt and/or the sequence of already drafted (and/or verified) tokens as input to the draft model in order to generate a set of probabilities for a set of output logits (e.g., tokens). Collectively, this set of probabilities may form a probability distribution for the generated tokens.

At block 310, the computing system adds a token, from the set of generated tokens, to the sequence of draft tokens being generated during the current drafting phase. For example, if the set of tokens correspond to the first iteration of the current drafting phase, the computing system may establish or initialize the sequence of draft tokens with the selected token. Similarly, if one or more tokens have already been added to the sequence during the current drafting phase, the computing system may append the newly selected token to the end of the sequence.

Generally, the computing system may select the token, from the set of tokens, to be added to the sequence of draft tokens using a variety of criteria and techniques. For example, in some aspects, the computing system may select the draft token (from the set of draft tokens) having the highest probability score generated by the draft model. In some aspects, other techniques which are not purely greedy may be used.

At block 315, the computing system determines the probability distribution of the newly generated set of tokens (generated at block 305). That is, as discussed above, the computing system may generate a respective probability for each respective token. The computing system may then treat this set of probabilities as an overall probability distribution for the draft model (e.g., representing the probability distribution of the output of the draft model for the current iteration).

At block 320, the computing system computes an entropy for the set of tokens (generated at block 305) based on the probability distribution (determined at block 315). For example, as discussed above, the computing system may compute H(DM) to quantify the entropy of the draft model's predictions for the current iteration of the current drafting phase.

At block 325, the computing system determines whether one or more early-exit thresholds are satisfied. For example, as discussed above, the computing system may compute an early-exit score (e.g., score using Equation 1 above) based on the entropy. This score can then be compared against the early-exit threshold (e.g., λ).

If, at block 325, the computing system determines that the early-exit threshold is satisfied (e.g., if the entropy and/or early-exit score is greater than the early-exit threshold), the computing system determines to terminate, exit, or otherwise end the current drafting phase, and the method 300 continues to block 335, discussed in more detail below.

Returning to block 325, if the computing system determines that the early-exit threshold is not satisfied, the method 300 proceeds to block 330. At block 330, the computing system determines whether one or more length criteria (or other criteria) are satisfied. For example, in some aspects, the computing system may determine whether the current sequence of draft tokens (for the current drafting phase) is less than the defined maximum draft length. If not (e.g., if the sequence is greater than or equal to the limit), the method 300 continues to block 335. As another example, in some aspects, the computing system may determine whether the current sequence of draft tokens, if verified and added to the current sequence of output tokens (generated and/or verified by the target model), would cause the current sequence of output tokens to meet or exceed an overall response length limit, as discussed above. As yet another example, in some aspects, the computing system may determine whether the token, added to the sequence of draft tokens at block 310, corresponds to a “stop” token or other token indicating the end of the drafting phase.

If, at block 330, the computing system determines that the length criteria (or other termination criteria) are not satisfied, the method 300 returns to block 305 to generate the next token using the draft model. If, at block 330, the computing system determines that one or more of the criteria are satisfied, the method 300 continues to block 335. At block 335, the computing system returns the sequence of draft tokens (e.g., the draft tokens 140 of FIG. 1) for verification (e.g., by the target model 115 of FIG. 1). For example, as discussed above, the target model may be used to accept or reject each token in the sequence of draft tokens, where accepted tokens are appended to the ongoing sequence of output tokens and rejected tokens are discarded.

### Example Method for Adaptive Exiting Criteria in Entropy-Based Speculative Decoding

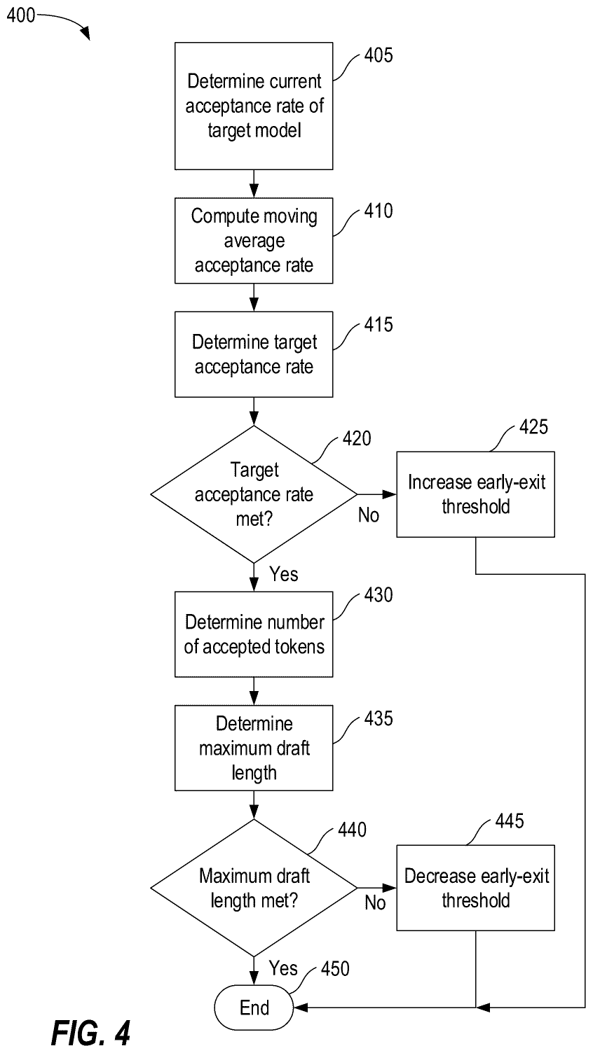

FIG. 4 is a flow diagram depicting an example method 400 for adaptive exiting criteria in entropy-based speculative decoding, according to some aspects of the present disclosure. In some aspects, the method 400 is performed by a computing system (e.g., a speculative decoding system), such as the computing system discussed above with reference to FIGS. 1-3. In some aspects, the method 400 is performed subsequent to token verification by the target model (e.g., performed at block 230 of FIG. 2).

At block 405, the computing system determines the current acceptance rate of the target model. That is, as discussed above, the computing system may determine the current percentage of draft tokens (e.g., from the draft tokens 140 of FIG. 1) that were generated by the draft model in the most recent drafting phase and were verified or accepted by the target model during the current verification phase. In some aspects, as discussed above, the current acceptance rate for the most recent drafting phase is defined as a current.

At block 410, the computing system computes an updated moving average acceptance rate of the target model based on the current acceptance rate. For example, as discussed above, the computing system may use the current acceptance rate (α_{current}) and the prior moving acceptance rate (e.g., α_{previous_ma} determined during the previous verification phase) to generate an updated moving average acceptance rate (e.g., α_{updated_ma}), such as by using Equation 2. In other aspects other measures may be used (e.g., exponential moving averages, etc.)

At block 415, the computing system determines the target or desired acceptance rate for the target model. For example, as discussed above, the target acceptance rate may be a hyperparameter of the model or generation process.

At block 420, the computing system determines whether the current moving average acceptance rate is less than the target acceptance rate. If so, the method 400 continues to block 425, where the computing system increases the early-exit threshold. That is, if the computing system determines that the target model is currently accepting fewer draft tokens than the target rate, the computing system may determine to increase the early-exit threshold (e.g., 1), thereby determining to exit the drafting phase when the entropy of the draft model is relatively lower (e.g., when the exit score, such as generated using Equation 1, is higher), as compared to the previous drafting phase. Stated differently, the computing system may determine that the computing system should end the drafting phase sooner and/or when entropy is relatively lower (thereby generating fewer tokens during each drafting phase), because the target model is accepting a lower percentage of the draft tokens than desired. For example, in some aspects, the computing system may use Equation 3 and/or Equation 5 to update the threshold. The method 400 then terminates at block 450 (e.g., to begin the next drafting phase with the updated early-exit threshold).

Returning to block 420, if the computing system determines that the current moving average acceptance rate is not less than (e.g., is greater than or equal to) the target acceptance rate, the method 400 continues to block 430. At block 430, the computing system determines the number of draft tokens, from the sequence of draft tokens generated during the most recent drafting phase, that were accepted by the target model.

At block 435, the computing system determines a maximum draft length for the models. That is, the computing system may determine the maximum number of draft tokens that should be generated using the draft model prior to ending the drafting phase and verifying the draft tokens using the target model.

At block 440, the computing system determines whether the maximum draft length is met by the number of accepted tokens (determined at block 430). That is, the computing system may determine whether, during the most recent drafting phase, the draft model was used to generate the maximum number of tokens that can be generated for each drafting phase (e.g., whether early exiting based on model entropy was performed), as well as whether the target model rejected any of the generated tokens. If the maximum length was achieved and verified (e.g., the computing system did not early exit the drafting based on model entropy and the target model accepted all of the draft tokens), the method 400 terminates at block 450 without modifying the early-exit threshold. That is, if the computing system determines that the target model accepted all of the generated tokens, the computing system may refrain from modifying the early-exit threshold (e.g., to allow the moving average acceptance rate to be updated to reflect the high level of acceptance).

Returning to block 440, if the computing system determines that the maximum draft length was not met (e.g., that the draft model did not generate the maximum allowable number of tokens, defined by the maximum draft length), the method 400 continues to block 445, where the computing system decreases the early-exit threshold. That is, if the computing system determines that the target model did not accept the maximum draft length (e.g., because the computing system early exited from the draft model and did not generate the maximum number of tokens), the computing system may determine to decrease the early-exit threshold (e.g., A), thereby determining to continue the drafting phase even when the entropy of the draft model is relatively higher (as compared to the previous drafting phase). Stated differently, the computing system may determine that the computing system should continue the drafting phase even when entropy is relatively higher (thereby generating more tokens with fewer resources, as compared to the target model), because the current moving average acceptance rate is sufficiently high and the draft model exited prior to reaching the maximum draft length. For example, in some aspects, the computing system may use Equation 4 and/or Equation 5 to update the threshold. The method 400 then terminates at block 450.

In some aspects, as discussed above, the computing system may update the early-exit threshold directly (e.g., by adding or subtracting a hyperparameter). In some aspects, after updating the early-exit threshold, the computing system may update the actual threshold used by computing an updated moving average of the threshold, such as discussed above with reference to Equation 5.

### Example Method for Speculative Decoding

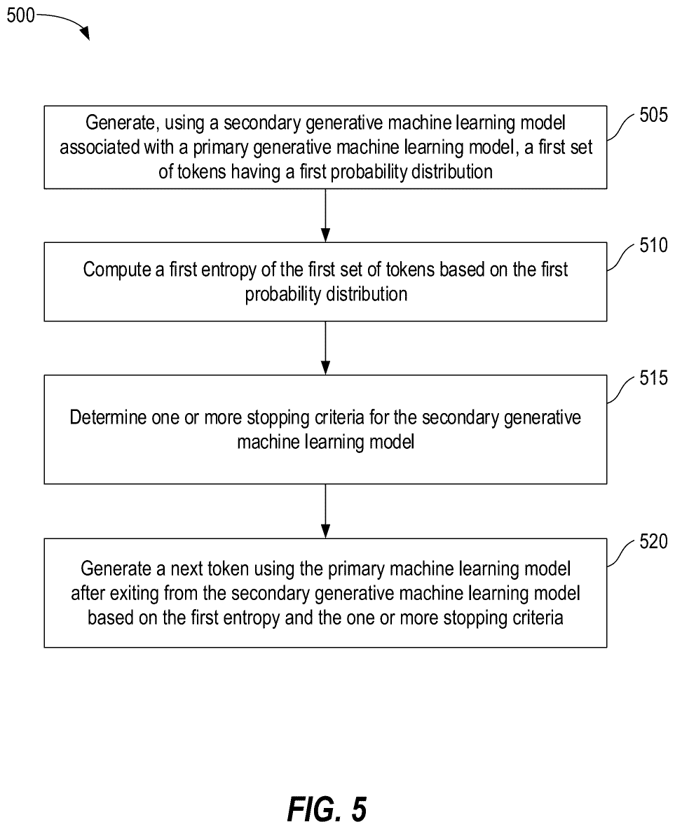

FIG. 5 is a flow diagram depicting an example method 500 for speculative decoding, according to some aspects of the present disclosure. In some aspects, the method 500 is performed by a computing system (e.g., a speculative decoding system), such as the computing system discussed above with reference to FIGS. 1-4.

At block 505, a first set of tokens (e.g., the tokens 125 of FIG. 1) having a first probability distribution is generated using a secondary generative machine learning model (e.g., the draft model 110 of FIG. 1) associated with a primary generative machine learning model (e.g., the target model 115 of FIG. 1).

At block 510, a first entropy of the first set of tokens is computed based on the first probability distribution.

At block 515, one or more stopping criteria for the secondary generative machine learning model are determined.

At block 520, a next token is generated using the primary generative machine learning model after exiting from the secondary generative machine learning model based on the first entropy and the one or more stopping criteria.

In some aspects, the method 500 further includes exiting from the secondary generative machine learning model in further response to determining, based on the first entropy, that the one or more stopping criteria are satisfied.

In some aspects, the method 500 further includes adding a first token, of the first set of tokens, to a sequence of draft tokens (e.g., the draft tokens 140 of FIG. 1), and submitting the sequence of draft tokens for evaluating each respective draft token of the sequence of draft tokens using the primary generative machine learning model.

In some aspects, the method 500 further includes determining, based on the evaluation of each respective draft token of the sequence of draft tokens, an acceptance rate of the secondary generative machine learning model, and updating at least one of the one or more stopping criteria based on the acceptance rate.

In some aspects, updating the at least one of the one or more stopping criteria comprises determining a moving average of the acceptance rate and comparing the moving average with a target acceptance threshold.

In some aspects, updating the at least one of the one or more stopping criteria comprises, in response to determining that the moving average is less than the target acceptance threshold, increasing an early-exit threshold for the secondary generative machine learning model.

In some aspects, updating the at least one of the one or more stopping criteria comprises, in response to determining that the moving average is not less than the target acceptance threshold, determining a number of tokens, from the sequence of draft tokens, accepted by the primary generative machine learning model and comparing the number of tokens with a maximum length of the sequence of draft tokens.

In some aspects, updating the at least one of the one or more stopping criteria further comprises, in response to determining that the number of tokens is less than the maximum length, decreasing an early-exit threshold for the secondary generative machine learning model.

In some aspects, the method 500 further includes generating, using the secondary generative machine learning model, a second set of tokens having a second probability distribution and in response to determining, based on a second entropy of the second set of tokens, that the one or more stopping criteria are not satisfied, generating, using the secondary generative machine learning model, a third set of tokens.

In some aspects, the method 500 further includes adding a second token, of the second set of tokens, to a sequence of draft tokens, and in response to determining, based on a length of the sequence of draft tokens, that the one or more stopping criteria are satisfied, generating a next token using the primary generative machine learning model after exiting from the secondary generative machine learning model

In some aspects, determining that the one or more stopping criteria are not satisfied comprises: computing an early-exit score according to 1−\sqrt{γH(DM)}, wherein γ is a hyperparameter and H(DM) is the first entropy of the first set of tokens generated by the secondary generative machine learning model, and comparing the early-exit score with an early-exit threshold.

### Example Processing System for Machine Learning

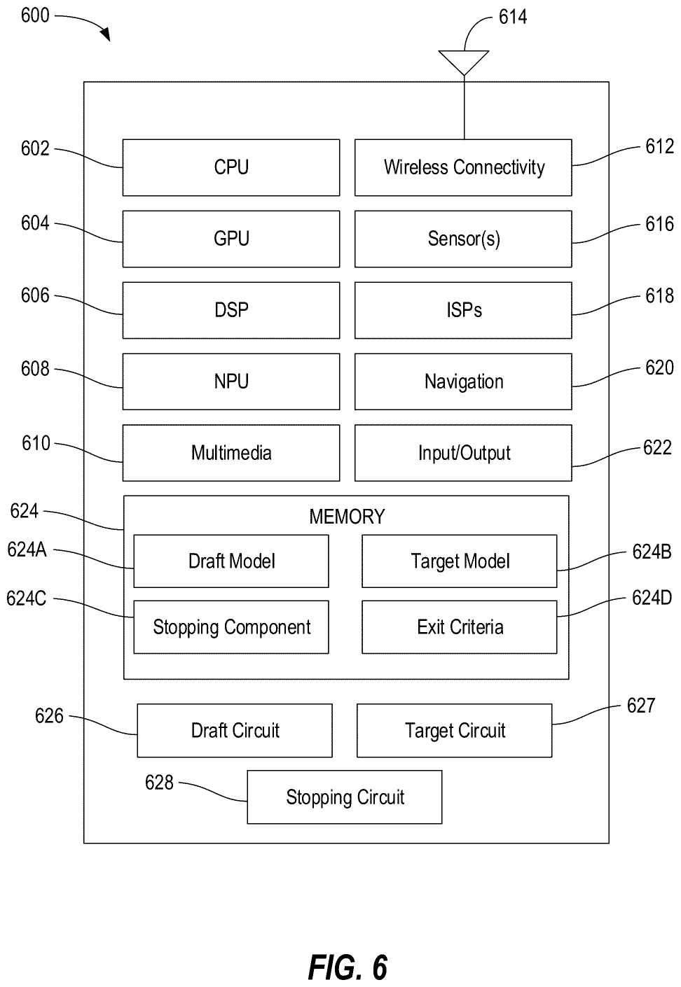

FIG. 6 depicts an example processing system 600 configured to perform various aspects of the present disclosure, including, for example, the techniques and methods described with respect to FIGS. 1-5. In some aspects, the processing system 600 may correspond to a speculative decoding system. For example, the processing system 600 may correspond to the computing systems discussed above with reference to FIGS. 1-5. Although depicted as a single system for conceptual clarity, in some aspects, as discussed above, the components described below with respect to the processing system 600 may be distributed across any number of devices or systems.

The processing system 600 includes a central processing unit (CPU) 602, which in some examples may be a multi-core CPU. Instructions executed at the CPU 602 may be loaded, for example, from a program memory associated with the CPU 602 or may be loaded from a memory partition (e.g., a partition of a memory 624).

The processing system 600 also includes additional processing components tailored to specific functions, such as a graphics processing unit (GPU) 604, a digital signal processor (DSP) 606, a neural processing unit (NPU) 608, a multimedia component 610 (e.g., a multimedia processing unit), and a wireless connectivity component 612.

An NPU, such as the NPU 608, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 608, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference). In some implementations, the NPU 608 is a part of one or more of the CPU 602, the GPU 604, and/or the DSP 606.

In some examples, the wireless connectivity component 612 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The wireless connectivity component 612 is further coupled to one or more antennas 614.

The processing system 600 may also include one or more sensor processing units 616 associated with any manner of sensor, one or more image signal processors (ISPs) 618 associated with any manner of image sensor, and/or a navigation processor 620, which may include satellite-based positioning system components (e.g., GPS or GLONASS) as well as inertial positioning system components.

The processing system 600 may also include one or more input and/or output devices 622, such as screens, touch-sensitive surfaces (including touch-sensitive displays), physical buttons, speakers, microphones, and the like.

In some examples, one or more of the processors of the processing system 600 may be based on an ARM or RISC-V instruction set.

The processing system 600 also includes a memory 624, which is representative of one or more static and/or dynamic memories, such as a dynamic random access memory, a flash-based static memory, and the like. In this example, the memory 624 includes computer-executable components, which may be executed by one or more of the aforementioned processors of the processing system 600.

In particular, in this example, the memory 624 includes a draft model 624A, a target model 624B, and a stopping component 624C. Although not depicted in the illustrated example, the memory 624 may also include other components, such as a training component used to train or update machine learning model(s), and the like. Though depicted as discrete components for conceptual clarity in FIG. 6, the illustrated components (and others not depicted) may be collectively or individually implemented in various aspects.

Further, in the illustrated example, the memory 624 also includes a set of exit criteria 624D (e.g., early-exit entropy-based thresholds, which may be dynamic or adaptive, or may be static). Although not depicted in the illustrated example, in some aspects, the memory 624 may include other data such as a training data for the machine learning model(s).

The processing system 600 further comprises a draft circuit 626, a target circuit 627, and a stopping circuit 628. The depicted circuits, and others not depicted (such as an inferencing circuit), may be configured to perform various aspects of the techniques described herein.

The draft model 624A and/or the draft circuit 626 (which may correspond to the draft model 110 of FIG. 1) may be used to generate generative machine learning model output using relatively less computational expense and/or latency, as compared to a target model, as discussed above. For example, the draft model 624A and/or the draft circuit 626 may correspond to a relatively small generative model, a subset of the components of the target model, and the like.

The target model 624B and/or the target circuit 627 (which may correspond to the target model 115 of FIG. 1) may be used to generate generative machine learning model output using relatively more computationally expensive models, as compared to the draft model, as discussed above. For example, the target model 624B and/or the target circuit 627 may correspond to a relatively large model with many parameters (e.g., an LLM).

The stopping component 624C and/or the stopping circuit 628 (which may correspond to the stopping component 130 of FIG. 1) may be used to determine when to early exit the drafting phase (e.g., based on entropy o the draft model output), as discussed above. For example, the stopping component 624C and/or the stopping circuit 628 may determine whether to early exit from the draft model based on evaluating the entropy of the draft model output using one or more equations and/or thresholds.

Though depicted as separate components and circuits for clarity in FIG. 6, the draft circuit 626, the target circuit 627, and the stopping circuit 628 may collectively or individually be implemented in other processing devices of the processing system 600, such as within the CPU 602, the GPU 604, the DSP 606, the NPU 608, and the like.

Generally, the processing system 600 and/or components thereof may be configured to perform the methods described herein.

Notably, in other aspects, aspects of the processing system 600 may be omitted, such as where the processing system 600 is a server computer or the like. For example, the multimedia component 610, the wireless connectivity component 612, the sensor processing units 616, the ISPs 618, and/or the navigation processor 620 may be omitted in other aspects. Further, aspects of the processing system 600 may be distributed between multiple devices.

### EXAMPLE CLAUSES

Implementation examples are described in the following numbered clauses:
Clause 1: A method, comprising: generating, using a secondary generative machine learning model associated with a primary generative machine learning model, a first set of tokens having a first probability distribution; computing a first entropy of the first set of tokens based on the first probability distribution; determining one or more stopping criteria for the secondary generative machine learning model; and generating a next token using the primary generative machine learning model after exiting from the secondary generative machine learning model based on the first entropy and the one or more stopping criteria.
Clause 2: A method according to Clause 1, further comprising exiting from the secondary generative machine learning model in further response to determining, based on the first entropy, that the one or more stopping criteria are satisfied.
Clause 3: A method according to Clause 1, further comprising: adding a first token, of the first set of tokens, to a sequence of draft tokens; and submitting the sequence of draft tokens for evaluating each respective draft token of the sequence of draft tokens using the primary generative machine learning model.
Clause 4: A method according to Clause 3, further comprising: determining, based on the evaluation of each respective draft token of the sequence of draft tokens, an acceptance rate of the secondary generative machine learning model; and updating at least one of the one or more stopping criteria based on the acceptance rate.
Clause 5: A method according to Clause 4, wherein updating the at least one of the one or more stopping criteria comprises: determining a moving average of the acceptance rate; and comparing the moving average with a target acceptance threshold.
Clause 6: A method according to Clause 5, wherein updating the at least one of the one or more stopping criteria comprises, in response to determining that the moving average is less than the target acceptance threshold, increasing an early-exit threshold for the secondary generative machine learning model.
Clause 7: A method according to Clause 5, wherein updating the at least one of the one or more stopping criteria comprises, in response to determining that the moving average is not less than the target acceptance threshold: determining a number of tokens, from the sequence of draft tokens, accepted by the primary generative machine learning model; and comparing the number of tokens with a maximum length of the sequence of draft tokens.
Clause 8: A method according to Clause 7, wherein updating the at least one of the one or more stopping criteria further comprises, in response to determining that the number of tokens is less than the maximum length, decreasing an early-exit threshold for the secondary generative machine learning model.
Clause 9: A method according to any of Clauses 1-8, further comprising: generating, using the secondary generative machine learning model, a second set of tokens having a second probability distribution; and in response to determining, based on a second entropy of the second set of tokens, that the one or more stopping criteria are not satisfied, generating, using the secondary generative machine learning model, a third set of tokens.
Clause 10: A method according to Clause 9, further comprising: adding a second token, of the second set of tokens, to a sequence of draft tokens; and in response to determining, based on a length of the sequence of draft tokens, that the one or more stopping criteria are satisfied, exiting from the secondary generative machine learning model for generation of a next token using the primary generative machine learning model.
Clause 11: A method according to any of Clauses 1-10, wherein exiting from the secondary generative machine learning model comprises exiting from the secondary generative machine learning model for generation of a next token using the primary generative machine learning model.
Clause 12: A method according to any of Clauses 1-11, wherein determining that the one or more stopping criteria are not satisfied comprises: computing an early-exit score according to 1−\sqrt{γH(DM)}, wherein γ is a hyperparameter and H(DM) is the first entropy of the first set of tokens generated by the secondary generative machine learning model; and comparing the early-exit score with an early-exit threshold.
Clause 13: A processing system comprising: a memory comprising processor-executable instructions; and one or more processors coupled to the one or more memories and configured to execute the processor-executable instructions and cause the processing system to perform a method in accordance with any of Clauses 1-12.
Clause 14: A processing system comprising means for performing a method in accordance with any of Clauses 1-12.
Clause 15: A non-transitory computer-readable medium comprising computer-executable instructions that, when executed by one or more processors of a processing system, cause the processing system to perform a method in accordance with any of Clauses 1-12.
Clause 16: A computer program product embodied on a computer-readable storage medium comprising code for performing a method in accordance with any of Clauses 1-12.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system comprising:
one or more memories comprising processor-executable instructions; and
one or more processors coupled to the one or more memories and configured to execute the processor-executable instructions and cause the processing system to:
generate, using a secondary generative machine learning model associated with a primary generative machine learning model, a first set of tokens having a first probability distribution;
compute a first entropy of the first set of tokens based on the first probability distribution;
determine one or more stopping criteria for the secondary generative machine learning model; and
generate a next token using the primary generative machine learning model after exiting from the secondary generative machine learning model based on the first entropy and the one or more stopping criteria.

2. The processing system of claim 1, wherein the one or more processors are configured to execute the processor-executable instructions and further cause the processing system to exit from the secondary generative machine learning model in response to determining, based on the first entropy, that the one or more stopping criteria are satisfied.

3. The processing system of claim 1, wherein the one or more processors are configured to execute the processor-executable instructions and further cause the processing system to:
add a first token, of the first set of tokens, to a sequence of draft tokens; and
submit the sequence of draft tokens for evaluating each respective draft token of the sequence of draft tokens using the primary generative machine learning model.

4. The processing system of claim 3, wherein the one or more processors are configured to execute the processor-executable instructions and further cause the processing system to:
determine, based on the evaluation of each respective draft token of the sequence of draft tokens, an acceptance rate of the secondary generative machine learning model; and
update at least one of the one or more stopping criteria based on the acceptance rate.

5. The processing system of claim 4, wherein, to update the at least one of the one or more stopping criteria, the one or more processors are configured to execute the processor-executable instructions and cause the processing system to:
determine a moving average of the acceptance rate; and
compare the moving average with a target acceptance threshold.

6. The processing system of claim 5, wherein, to update the at least one of the one or more stopping criteria, the one or more processors are configured to execute the processor-executable instructions and further cause the processing system to increase an early-exit threshold for the secondary generative machine learning model in response to determining that the moving average is less than the target acceptance threshold.

7. The processing system of claim 5, wherein, to update the at least one of the one or more stopping criteria, the one or more processors are configured to execute the processor-executable instructions and further cause the processing system to, in response to determining that the moving average is not less than the target acceptance threshold:
determine a number of tokens, from the sequence of draft tokens, accepted by the primary generative machine learning model; and
compare the number of tokens with a maximum length of the sequence of draft tokens.

8. The processing system of claim 7, wherein, to update the at least one of the one or more stopping criteria, the one or more processors are configured to execute the processor-executable instructions and further cause the processing system to decrease the early-exit threshold for the secondary generative machine learning model in response to determining that the number of tokens is less than the maximum length.

9. The processing system of claim 1, wherein the one or more processors are configured to execute the processor-executable instructions and further cause the processing system to:
generate, using the secondary generative machine learning model, a second set of tokens having a second probability distribution; and
generate, using the secondary generative machine learning model, a third set of tokens in response to determining, based on a second entropy of the second set of tokens, that the one or more stopping criteria are not satisfied.

10. The processing system of claim 8, wherein the one or more processors are configured to execute the processor-executable instructions and further cause the processing system to:
add a second token, of the second set of tokens, to a sequence of draft tokens; and
generate a next token using the primary generative machine learning model after exiting from the secondary generative machine learning model in response to determining, based on a length of the sequence of draft tokens, that the one or more stopping criteria are satisfied.

11. The processing system of claim 1, wherein, to determine that the one or more stopping criteria are not satisfied, the one or more processors are configured to execute the processor-executable instructions and cause the processing system to:
compute an early-exit score according to 1−\sqrt{γH(DM)}, wherein γ is a hyperparameter and H(DM) is the first entropy of the first set of tokens generated by the secondary generative machine learning model; and
compare the early-exit score with an early-exit threshold.

12. A processor-implemented method for machine learning, comprising:
generating, using a secondary generative machine learning model associated with a primary generative machine learning model, a first set of tokens having a first probability distribution;
computing a first entropy of the first set of tokens based on the first probability distribution;
determining one or more stopping criteria for the secondary generative machine learning model; and
generating a next token using the primary generative machine learning model after exiting from the secondary generative machine learning model based on the first entropy and the one or more stopping criteria.

13. The method of claim 12, further comprising exiting from the secondary generative machine learning model in further response to determining, based on the first entropy, that the one or more stopping criteria are satisfied.

14. The method of claim 12, further comprising:
adding a first token, of the first set of tokens, to a sequence of draft tokens; and
submitting the sequence of draft tokens for evaluating each respective draft token of the sequence of draft tokens using the primary generative machine learning model.

15. The method of claim 14, further comprising:
determining, based on the evaluation of each respective draft token of the sequence of draft tokens, an acceptance rate of the secondary generative machine learning model; and
updating at least one of the one or more stopping criteria based on the acceptance rate.

16. The method of claim 15, wherein updating the at least one of the one or more stopping criteria comprises:
determining a moving average of the acceptance rate; and
comparing the moving average with a target acceptance threshold.

17. The method of claim 16, wherein updating the at least one of the one or more stopping criteria comprises, in response to determining that the moving average is less than the target acceptance threshold, increasing an early-exit threshold for the secondary generative machine learning model.

18. The method of claim 17, wherein updating the at least one of the one or more stopping criteria comprises, in response to determining that the moving average is not less than the target acceptance threshold:
determining a number of tokens, from the sequence of draft tokens, accepted by the primary generative machine learning model;
comparing the number of tokens with a maximum length of the sequence of draft tokens; and
in response to determining that the number of tokens is less than the maximum length, decreasing an early-exit threshold for the secondary generative machine learning model.

19. The method of claim 12, further comprising:
generating, using the secondary generative machine learning model, a second set of tokens having a second probability distribution;
in response to determining, based on a second entropy of the second set of tokens, that the one or more stopping criteria are not satisfied, generating, using the secondary generative machine learning model, a third set of tokens;
adding a second token, of the second set of tokens, to a sequence of draft tokens; and
generating a next token using the primary generative machine learning model after exiting from the secondary generative machine learning model in response to determining, based on a length of the sequence of draft tokens, that the one or more stopping criteria are satisfied.

20. A processing system, comprising:
means for generating, using a secondary generative machine learning model associated with a primary generative machine learning model, a set of tokens having a probability distribution;
means for computing an entropy of the set of tokens based on the probability distribution;
means for determining one or more stopping criteria for the secondary generative machine learning model; and
means for generating a next token using the primary generative machine learning model after exiting from the secondary generative machine learning model based on the entropy and the one or more stopping criteria.
